(19) United States
(12) Patent Application Publication
(10) Pub. No.: US 2010/0184420 A1
(43) Pub. Date: Jul. 22, 2010

(54) Method and Apparatus for Prolonging Battery Life in a Mobile Communication Device Using Motion Detection

(76) Inventors: Stanley Reinhold, Allentown, PA (US); Xiao-An Wang, Allentown, PA (US)

Correspondence Address: IP Legal Services, 1500 East Lancaster Avenue, Suite 200, P.O. Box 1027, Paoli, PA, 19301, US

(21) Appl. No.: 12/446,478

(22) PCT Filed: Nov. 29, 2006
(86) PCT No.: PCT/US06/45941

§ 371 Date: Apr. 21, 2009

(51) Int. Cl. H04M 3/00

(52) U.S. Cl. 455/418

(57) ABSTRACT

A telecommunication device is equipped with circuitry that can detect phenomena indicative or predictive of motion of the telecommunications device, such as GPS circuitry. When the circuitry determines that the telecommunication device is stationary, it controls the device to perform neighboring cell polling at relatively large intervals or not at all. However, when the circuitry determines that the telecommunication device is moving, it controls the device to poll neighboring cells more frequently.

### FIELD OF THE INVENTION

The invention pertains to wireless communication devices and particularly such devices that operate on battery power, such as cellular telephones. More particularly, the invention pertains to a method and apparatus for minimizing power requirements and prolonging battery charge life in such devices.

### BACKGROUND OF THE INVENTION

A mobile telecommunication device, such as a cellular telephone or a police mobile radio, communicates with other telecommunication devices via transmission and reception of radio frequency (RF) signals with base stations that are part of a wireless network telecommunication system. The overall telecommunication system may, of course, also include a wired portion. Using cellular telephones as merely one example, FIG. 1 illustrates the basic components of a typical cellular telecommunication system 10. In such a system, the cellular telephone network comprises a plurality of stationary base stations 12 geographically separated from each other. Each base station covers a small geographic area (or cell) 19 surrounding the base station 12. Cells 19 typically overlap with each other so as to assure full coverage of an overall geographic area. A cellular telephone such as cellular telephone 14a establishes contact and communicates with the base station that provides the strongest signal such as base station 12a via RF signals 16. The base stations are coupled to a wired communication network 18 that routes the call through the wired network 18 to another telecommunication device. The other telecommunication device may, for instance, be another cellular telephone 14b, in which case the signals are routed from the wired network 18 to another cellular base station 18b that is close to the other cellular telephone 14b, where they are converted to RF signals 16 and broadcast to the cellular telephone 14b.

In order to provide an efficient communication system, it is important for the network as well as each cellular telephone to keep track of which cellular base station is closest to the telephone. Particularly, each telephone 14 should know which cellular base station 18 provides the strongest signal so that it can communicate with that station rather than any other station so as to minimize the amount of power required to transmit to the network. Also, the network must keep track of the base station that has the best communication link with each cellular telephone for the same reasons and also so that it can know which base station to route a call to when a call for a particular cellular telephone is made.

Hence, a cellular telephone 14 typically will wake up from a standby mode to listen for a page from the base stations at predetermined intervals. A paging interval for a typical cellular telecommunications system might be in the range of about 0.5 seconds-2.5 seconds. The page period typically may be about 25-100 milliseconds in duration. Specifically, during a conventional page, the cellular telephone will have previously determined a default base station with which to communicate based on the preceding page or pages. The telephone will turn on its receive circuitry to listen for transmissions from the default base station to determine, for instance, if the base station is transmitting a signal indicating that the telephone has an incoming call. This process will herein be referred to “monitoring” the default base station. In addition, during the page, the telephone checks the signal strength of the default base station as well as any other base stations with which it can communicate to assure that it is always talking to the base station with the strongest signal (presumably, although not necessarily, the closest base station). This process will herein be termed “polling”. In a typical neighboring cell polling process, the telephone listens on the various frequencies that neighboring base stations may be transmitting on for signals from any base stations within range. The cellular telephone then determines the received signal strength of every base station that responds and determines if any of the responding base stations has a received signal strength greater than that of the default base station.

If during neighboring cell polling; the telephone determines that there is a neighboring cell base station with a stronger signal, the telephone will switch the default base station to the new base station. It will be understood by persons of skill in this art that the above description is highly simplified and that many systems will incorporate more complex algorithms that take into consideration various criteria in determining which cellular base station provides (or at least is likely to provide) the best communication link for any given telephone and, therefore, will be designated as the default base station.

As previously noted a cellular telephone page may typically require about 25-100 milliseconds, of which about half is consumed monitoring the default base station and the other half is consumed polling neighboring cells. During paging, the cellular telephone is consuming substantially more power than when it is in standby mode. Specifically, essentially all of the receive path circuitry, including filters and amplifiers are turned on and adjusted. In addition, the processor is processing data, such as the received signal strength data for all of the neighboring base stations and determining which provides the best signal.

Paging is one of the biggest drains on a battery of a cellular telephone. A typical cellular telephone, for instance, may draw on the order of 25 to 50 times as much power from the battery when paging than when it is in standby.

A common goal in the design of essentially all mobile telecommunication devices is to minimize its power consumption so that the battery can last as long as possible between charges and/or so as to reduce the size of the battery so that the telecommunication device can be made smaller and lighter.

Accordingly, it is an object of the present invention to minimize power consumption in a mobile telecommunications device.

It is another object of the present invention is to minimize the amount of time spent polling neighboring cells in a mobile telecommunication device.

### SUMMARY OF THE INVENTION

In accordance with the invention, a telecommunication device is equipped with a global positioning system (GPS) or other circuitry for detecting a phenomenon indicative of a change in the location or a movement of the telecommunications device. Such other circuitry may include accelerometers for determining the acceleration of the telecommunication device (with or without integrators for converting acceleration into velocity or distance). Alternately, changes in default base station signal strength may be used as an indicator of movement of the device.

In accordance with the principles of the invention, GPS or other circuitry is used to determine if the telecommunication device has moved. During the periods when the telecommunication device is determined to be essentially stationary, the telecommunication device remains in a stationary mode during which it either does not perform neighboring base station polling or polls neighboring base stations at much larger intervals than when the device is determined to be moving.

Upon detection of movement, the device enters a mobile mode, in which the device polls neighboring cells at a smaller interval. It remains in the mobile mode until it determines that the device has become stationary again.

### BRIEF DESCRIPTION OF THE DRAWINGS

FIG. 1 is a block diagram illustrating some of the basic components of a conventional wireless telecommunication network device.

FIG. 2 is a block diagram of some of the basic components of a wireless telecommunication device in accordance with the principles of the present invention.

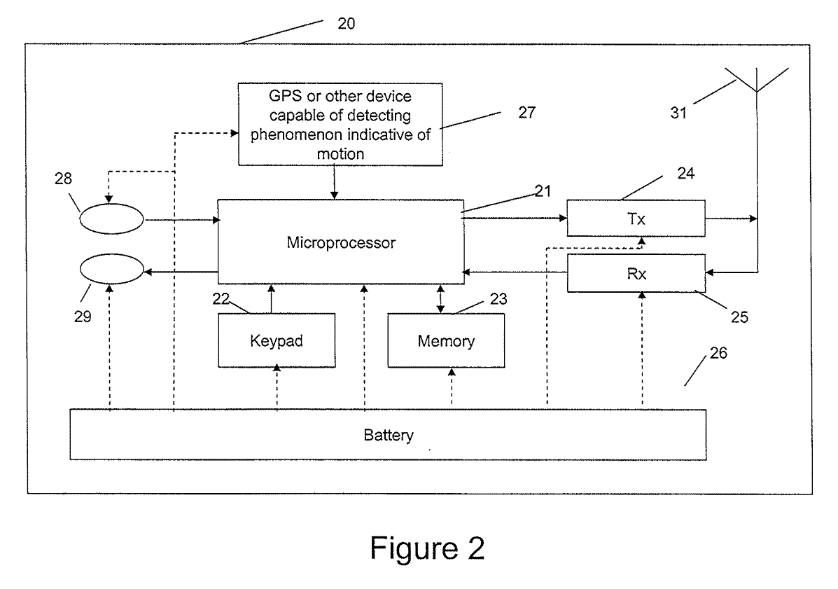

FIG. 3 is a flow diagram illustrating steps in accordance with one embodiment of the present invention.

### DETAILED DESCRIPTION OF THE INVENTION

In accordance with the principles of the present invention, the battery life of a mobile or wireless telecommunication device is increased by increasing the interval between polling of neighboring base stations when the device is stationary. The invention will be described herein in connection with an exemplary cellular telephone wireless network. However, the invention has much broader application to virtually any wireless communication device designed to poll a plurality of base stations in order to determine which one it should use for communications. The invention has applications, for instance, in military communication systems, satellite-based communication systems, police and fire telecommunication systems, commercial wireless communication systems (taxis, trucking companies), etc.

Cell phones typically employ a paging interval of between about 0.5 seconds and 2.5 seconds between pages. During the page period, the telecommunication device listens to the default base station in order to receive information from it. It also polls neighboring cellular base stations in order to determine signal strength of all neighboring base stations within range in preparation for potentially switching to a new default base station should the signal strength for a particular neighboring base station become stronger than the signal strength for the default base station. In a typical cell phone, both of these functions, i.e., monitoring the default base station and polling the neighboring base stations, are performed during each page, with each consuming a certain portion of time.

This frequent polling of neighboring base stations is necessary in order to provide the quality of service deemed necessary by mobile communication device users. The paging period (the duration for which the telephone receive path circuitry and digital data processing is turned on, e.g., for purposes of monitoring and polling) is on the order of about 25-100 milliseconds for a typical cell phone, with about half of that time dedicated to monitoring the default base station and the other half of that time dedicated to the polling of neighboring cells. Paging consumes a lot of power in a telecommunication device. Accordingly, it is a goal of the present invention to increase the interval between the polling of neighboring base stations in order to reduce the power consumed by the device, and thereby, increase battery life.

The invention achieves this goal by increasing the interval between polling of neighboring base stations (or completely ceasing such polling) when the device is stationary (i.e., fails to move a predetermined distance).

Many portable wireless telecommunication devices, and particularly cellular telephones, are now manufactured with a built-in global positioning system (GPS). Such GPS systems have many valuable applications in cellular telephones and other mobile communication devices. For instance, a cellular telephone equipped with GPS can be used to locate the user of the telephone in an emergency situation by transmitting its location to the network. Furthermore, GPS can be used in connection with convenience features such as application software that can determine the location of the cellular telephone and then provide directions to the user to locations of interest, such as the nearest movie theater, the nearest Ethiopian restaurant, or the nearest public restroom.

In addition, the GPS system can be used to detect movement of the cellular telephone and that information can be used to regulate the neighboring base station polling interval. A GPS system determines its location by receiving signals from satellites and then triangulating its position on the face of the Earth relative to three or more satellites from which it receives signals.

In any event, under good environmental conditions, GPS systems can detect changes in position down to about 15 to 30 feet. A typical cell (i.e., the geographic area serviced by a single cellular base station) is on the order of about 1-3 miles. Hence, the distance resolution of GPS is much finer than the typical distance that a cellular telephone would have to move it in order for it to switch default cellular base stations.

In accordance with the present invention, a cellular telephone equipped with GPS can be programmed to determine when the cellular telephone has moved a certain predetermined minimum distance (e.g., 100 feet). The telephone may be programmed to enter and remain in a stationary mode of operation in which it polls neighboring cells at relatively large intervals (i.e., at a relatively low frequency) as long as the distance the device has moved since entering the stationary mode is less than the predetermined distance. That predetermined distance may be the minimum resolution of the GPS (or other motion detection) apparatus (i.e., any detectable motion). However, when the microprocessor detects movement greater than the predetermined distance, it switches to a mobile mode, in which it polls neighboring base stations at a much smaller interval (i.e., at a greater frequency). In an alternate embodiment, polling can be entirety ceased (i.e., the polling interval is infinite) until the detection of movement of the predetermined minimum distance since the device entered that stationary mode.

Note that the monitoring portion of paging preferably, although not necessarily, continues to be performed at the same, relatively small intervals regardless of whether the device is in the mobile mode or the stationary mode; Only the interval of the polling process is altered in one preferred embodiment. Thus, for instance, in one embodiment of the invention, when the device is in the mobile mode, the polling process is performed every paging period, whereas, when the device is in the stationary mode, the polling process is performed only once every X′ paging periods, where X is a reasonable integer such as 5-50. In this manner and using X=50 as an example, the paging period is reduced by about one half for 49 out of every 50 pages, thus considerably reducing the drain of the battery.

In further embodiments of the invention in which polling is not entirely ceased in stationary mode, but instead is reduced in frequency, the device may be controlled to switch between modes based on a detected minimum velocity of the device, rather than a minimum charge in position (i.e., distance). A velocity of the device may be calculated by dividing a detected distance of movement by the time period in which it occurred. Alternately, velocity (rather than distance) may be detected directly, such as by the use of accelerometers and integrators, as discussed more fully below.

In one preferred embodiment of the invention, the device will remain in the mobile mode for a certain predetermined period of time after the last motion (or velocity) is detected.

Merely as one example of a preferred method in accordance with the principles of the present invention, the device may be designed to remain in the mobile mode until 60 seconds after the last movement of the telecommunication device is detected. Thus, for instance, in one embodiment, once the communication device enters the mobile mode, it stays in that mode as long as any motion is detected within 60 seconds of the last detection of any motion. In a simple embodiment, a timer is started when the device enters the mobile mode and counts to 60 seconds. The timer is reset whenever any further motion is detected while the device is in the mobile mode. In another embodiment, the amount of motion required to reset the timer in the mobile mode can be set to some minimum distance in a predetermined period of time, for instance, 30 feet in 30 seconds.

The (1) minimum distance for entering the mobile mode, (2) amount of time for which detected motion must not occur in order to reset into the stationary mode, (3) polling interval in the stationary mode, and (4) the polling interval in the mobile mode can all be set in accordance with practical considerations. The examples given above are merely exemplary.

In one example, the mobile mode polling interval can be about 0.5 seconds to 2.5 seconds, the stationary mode polling interval can be about 2.5 seconds to 1 minute, the minimum distance for switching to the mobile mode can be about 15 feet to about 150 feet, the amount of time since the last detected motion required to re-enter the stationary mode can be about 20 seconds to about 3 minutes, and the minimum detected distance required to remain in the mobile mode (i.e., to reset the return-to-stationary-mode timer) can be anywhere from the minimum distance resolution of the distance detection circuitry to about 50 feet over a period of 30 seconds. In one particularly preferred embodiment, the stationary mode polling interval is 10 seconds, the mobile mode polling interval is 1 second, the minimum distance for switching to the mobile mode is 15 feet, the amount of time since the last detected motion required to re-enter the stationary mode is 60 seconds, and the minimum detected distance required to remain in the mobile mode (i.e., reset the aforementioned 60 second time period) is the minimum distance resolution of the distance detection circuitry.

It is advisable to remain in the mobile mode for a predetermined time, such as 60 seconds, after the cessation of movement because there are many circumstances under which a telecommunication device may still be moving, but not being detected immediately. For instance, sometimes the telecommunication device may lose contact with the GPS satellites, particularly under heavy cloud cover, thus preventing detection of continued motion for a short period of time. Alternately, a walking a person may be moving relatively slowly relative to the 15 to 30 foot resolution of GPS. Accordingly, a person walking slowly may lead to a situation in which the continuous movement of that person is not detected for several seconds. Also, once motion has commenced, it is more likely that, even if motion ceases momentarily, it will commence again shortly. For instance, when someone is in a moving automobile, it may be necessary to stop at a traffic light or stop sign momentarily, but motion will commence again very shortly. Therefore, such a built-in time delay will prevent the device from bouncing between the mobile and stationary states unnecessarily frequently.

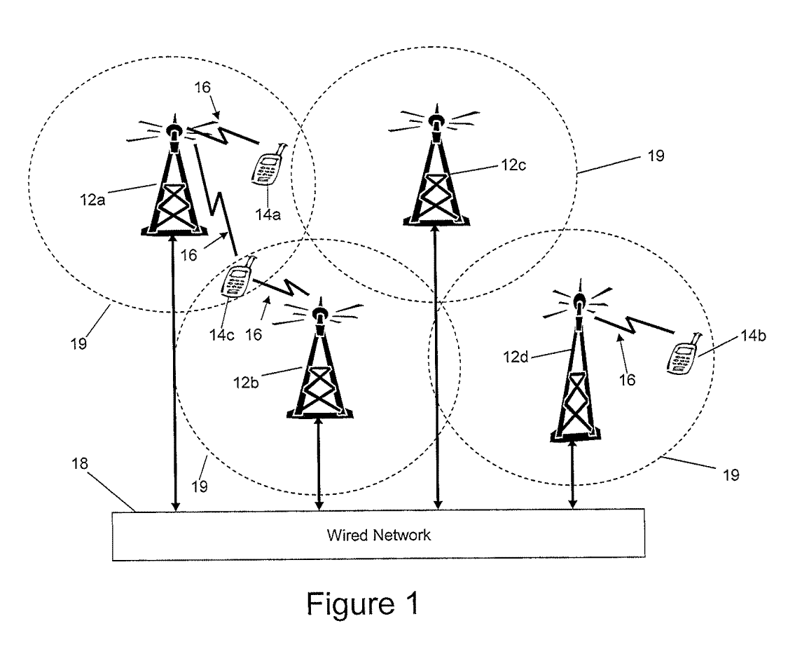

FIG. 1 is a block diagram of some of the basic components of an exemplary cellular telephone 20 in accordance with the principles of the present invention. The telephone 20 includes one or more microprocessors 21 for controlling the various functions of the telephone. It further includes a memory 23 for storing program instructions and data. The memory 23 may comprise one or more separate memory modules of one or more types. For instance, the program instructions may be stored in a non-volatile memory such as a read-only memory (ROM) or a programmable non-volatile memory, such as an EPROM or EEPROM, while data may be stored in a volatile memory such as a random access memory (RAM).

Furthermore, the device would include a GPS unit 27 or the like transmitting and receiving circuitry 24 and 25, respectively, and an antenna 31. In addition, the device would further include typical components found in cellular telephones such as a microphone 28, a speaker 29, and a keypad 22. Some or all of the aforementioned components would be powered via a rechargeable battery 26.

The steps, algorithms, and processes described herein above in connection with the present invention generally would be performed by the microprocessor 21, which, in turn would control the other components of the telephone as described herein. For instance, the microprocessor would turn on the receive circuitry 25 during the paging period.

The use of GPS to detect motion of the device is merely exemplary. Other techniques, apparatus, and/or circuitry can be used to detect motion or other phenomena reasonably likely to be indicative of motion of the device. For instance, one or more accelerometers may be embodied within the telecommunication device in order to detect acceleration of the device. In a simple embodiment of the invention, once acceleration of the device is detected, the device is caused to enter the mobile mode and remain in the mobile mode for a predetermined period of time after the last instance of acceleration is detected. While the lack of acceleration is not necessarily indicative of the lack of motion (but merely the lack of change in the velocity or direction of motion), as a practical matter, a person or vehicle in motion is likely to experience accelerations regularly as the result of rough pavement, hills, or the constant up and down accelerations of walking. In a more complex embodiment of the invention, the output(s) of the accelerometer(s) can be fed into one or more integrators that can be programmed to integrate the output of the accelerometers to convert it into velocity or even distance and that data (instead of the direct acceleration data) may be observed for detecting movement.

The telecommunication device may be equipped with six accelerometers adapted to detect acceleration in all six degrees of freedom, namely, X, Y, Z, and rotation about the X, Y, and Z axes. Such a system would provide the most accurate detection of movement, but would increase the size, weight, complexity and power requirements of the device. Particularly, the need to incorporate six accelerometers, the associated integrators, and the processing power needed to process all of this information would be significant. Accordingly, in a more preferred embodiment of the invention, only three accelerometers are utilized to detect acceleration in only the X, Y, and Z directions. Particularly, as a practical matter, rotational motion is largely irrelevant to the concept of the present invention insofar as it is the distance that the device moves linearly that would dictate whether it may be necessary to change the default base station, rather than any rotation of the device about a stationary axis.

In fact, only two or even one accelerometer may be sufficient to correctly detect motion at least the vast majority of times.

Just as described above in connection with the GPS-based embodiment of the invention, switching between the mobile and stationary modes may be subject to certain minimal distance, velocity, and/or time requirements.

In yet a further embodiment of the invention, rather than using GPS or accelerometers to detect motion, motion can be presumed from a significant change in received signal strength from the default cellular base station as determined during registration with the default base station.

Particularly, although the default base station signal strength detected by the cellular telephone often can change due to environmental conditions as well as changes in distance between the telephone and the base station, a change in signal strength greater than a particular minimum threshold typically will be a reasonable indicator of movement of the cellular telecommunication device. Furthermore, even if the communication device sometimes switches to the mobile mode erroneously due to a change in signal strength caused by an environmental condition other than motion, the system, on average, still will provide significant power savings by placing the device into stationary mode most of the time when the device is stationary.

As in the previously described embodiments, in a preferred embodiment, the system is programmed to enter the mobile mode when the signal strength from the default base station changes a predetermined amount, e.g., by more than 10% either since entering stationary mode or within a predetermined interval, for instance: during any 20 consecutive paging intervals; or over 10 seconds, then the device enters the mobile mode. It will remain in mobile mode as long as the signal strength continues to vary by more than a predetermined threshold (which may be the same 10% or a different value) within, e.g., 60 seconds. As before, a timer may be used that is reset every time the signal varies by more than 10% since the timer was last reset. Also, as previously described in connection with other embodiments of the invention, rather than changing the polling interval to a larger value, the device simply may perform no polling at all while in the stationary mode.

While we have described several different embodiments of the invention, all of these are merely exemplary. For instance, others techniques than those described above can be used to detect movement or at least phenomena considered to be reasonable indicators of movement. For instance, a barometric pressure sensor can be employed to detect changes in elevation, which would be a reasonable predictor of movement.

Furthermore, the techniques for detection of motion may be used in conjunction with each other. For instance, in one embodiment of the invention, GPS may be used to detect motion as previously described and no polling at all may occur when the device is in the stationary mode. However, if the received signal strength of the default base station changes by a predetermined amount while the device is in the stationary mode, then the device switches to the mobile mode or to a third mode, in which it does perform polling operations, but at a larger interval than in the mobile mode.

In other embodiments, there may be a plurality of stationary modes having different polling intervals. The particular stationary mode may be selected based on the amount of time a device appears to be stationary, switching to longer and longer intervals as the amount of time since motion was last detected increases.

Even further, in those embodiments in which polling does occur (at reduced frequency) while in the stationary mode, it may be advisable to include a feature whereby the device switches to mobile mode for a predetermined period of time after every change of default base station regardless of any detection of motion.

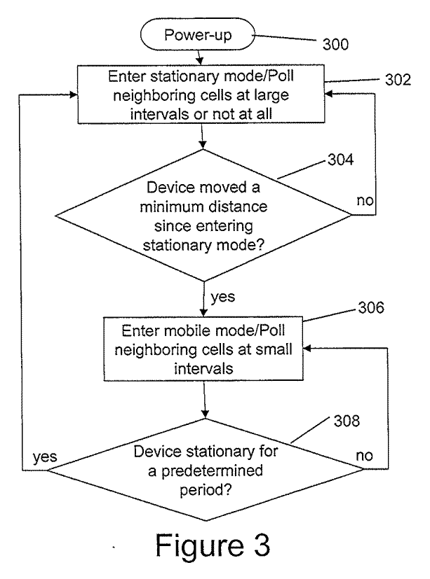

FIG. 3 is a flow diagram illustrating the basic steps in accordance with the present invention. Typically, these steps would be performed by the microprocessor 21 under the instructions of a software program. However, it is possible to perform the steps by other means, such as combinational logic circuitry, a state machine, analog or digital circuitry, etc.

The process starts at step 300, in a preferred embodiment of the invention, upon power-up, the device enters the stationary mode (step 302) in which neighboring cells are polled at a large interval (or not at all). However, in other embodiments of the invention, upon startup, the device may default to the mobile mode rather than the stationary mode.

In step 304, it is determined if the device has moved a predetermined minimum distance since entering the stationary mode using any of the techniques described herein above or any other suitable technique. If it has not, then the device remains in the stationary mode. If, however, such motion is detected, processing proceeds to step 306 in which the device enters the mobile mode, in which mode it polls the neighboring cells at a smaller interval. Next, in step 308, it is determined if the device has been stationary for a predetermined period of time in accordance with any of the techniques described herein above. If not, it remains in the mobile mode. If, however, it is determined in step 308 that the device has been stationary for the predetermined period of time, then processing flows back to step 302 and the device re-enters the stationary mode. The microprocessor runs through steps 302 through 308 until the device is powered down.

Having thus described a few particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

What is claimed is:

1. A method for use of a wireless communication device comprising the steps of:
polling base stations at fixed intervals of a first duration when said wireless communication device is stationary; and
polling said base stations at fixed intervals of a second duration when said wireless communication device is in motion.

2. A method according to claim 1, further comprising the step of:
determining if said wireless communication device is in motion;
wherein said first polling step is performed while said wireless communication device is determined to be in motion plus a predetermined period thereafter.

3. A method according to claim 2 wherein said determining step comprises detecting a physical phenomenon indicative of the likelihood of motion of said telecommunication device.

4. A method according to claim 2, wherein said determining step comprises detecting changes in position of said wireless communication device via GPS.

5. A method according to claim 2, wherein said determining step comprises detecting acceleration of said wireless communication device.

6. A method according to claim 5, wherein said determining step further comprises integrating said acceleration to calculate a velocity of said wireless communication device.

7. A method according to claim 5, wherein said determining step further comprises integrating said acceleration to calculate a distance moved by said wireless communication device.

8. A method according to claim 2, wherein said determining step comprises detecting changes in received signal strength from a selected base station.

9. A method according to claim 2, wherein said determining step further comprises determining if said wireless communication device has moved at least a predetermined minimum distance in a predetermined time period.

10. A method according to claim 9, wherein said predetermined time period is the length of time since said device has been in said stationary mode.

11. A method according to claim 1, wherein said base station polling step comprises:
receiving signals transmitted from base stations at various frequencies; and processing said received signals to determine a signal strength of each said received signal.

12. A method according to claim 2, wherein said telecommunication device periodically pages a particular base station at a third interval and wherein said first interval is a first integer multiple of said third interval and said second interval is a second integer multiple of said third interval smaller than said first integer multiple.

13. A method according to claim 2 wherein said second interval is infinite.

14. A method according to claim 2, wherein said first interval is in the range of about 2.5 seconds to about 10 seconds and said second interval is in the range of about 0.5 seconds to about 2.5 seconds.

15. A method according to claim 2, wherein said determining step comprises detecting a velocity of said device.

16. A method for a wireless communication device in a wireless communication network to poll a plurality of base stations for purposes of determining their respective signal strengths, said method comprising the steps of:
detecting motion of said wireless communication device;
switching from a first mode of operation in which a first polling interval is used and a second mode of operation in which a second polling interval is used, said first polling interval being longer than said second polling interval, responsive to detection of motion of said wireless communication device; and
switching from said second mode of operation to said first mode of operation responsive to failure to detect motion of said wireless communication device.

17. A method according to claim 16, wherein said first switching step comprises switching responsive to detection of motion of a first predetermined distance since said device was in said first mode of operation.

18. A method according to claim 17, wherein said second switching step comprises switching responsive to a failure to detect motion of a second predetermined distance for a predetermined period of time.

19. A wireless telecommunication device adapted to poll a plurality of base stations of a wireless telecommunication network comprising:
a transmitting circuit for transmitting signals to a base station;
a receiving circuit for receiving signals from a base station;
circuitry for detecting whether said telecommunication device it in motion; and
a processor adapted to control said transmitting circuit and said receiving circuit and for processing said transmitted and received signals, said processor adapted to control said receiving circuit to poll base stations at fixed intervals of a first duration when said wireless communication device is stationary and to poll said base stations at fixed intervals of a second duration when said wireless communication device is in motion.

20. A wireless telecommunication device according to claim 19, wherein said processor is further adapted to poll at said second interval while said wireless communication device is determined to be in motion plus a predetermined period thereafter.

21. A wireless telecommunication device according to claim 20, wherein said circuitry for detecting comprises a global positioning system.

22. A wireless telecommunication device according to claim 21, wherein said circuitry for detecting comprises an accelerometer.

23. A wireless telecommunication device according to claim 22, wherein said circuitry for detecting further comprises an integrator coupled to an output of said accelerometer.

24. A wireless telecommunication device according to claim 21, wherein said circuitry for detecting comprises circuitry for detecting changes in received signal strength from base stations.
